(19) United States
(12) Patent Application Publication
(10) Pub. No.: US 2008/0094281 A1
(43) Pub. Date: Apr. 24, 2008

(54) ADVANCED CODEBOOK FOR MULTI-ANTENNA TRANSMISSION SYSTEMS

(75) Inventors: Yong Teng, Beijing (CN); Klaus Hugi, Helsinki (FI); Olav Tirkkonen, Helsinki (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/832,907

(22) Filed: Aug. 2, 2007

(30) Foreign Application Priority Data
Oct. 24, 2006 (EP) 06022252.8

(51) Int. Cl. H01Q 3/30

(52) U.S. Cl. 342/368

(57) ABSTRACT

Various example embodiments are disclosed including methods, a system, a transmitter apparatus, a receiver apparatus, and computer program products which may provide advanced feedback signaling in a multi-antenna transmission system. In an example embodiment, a codebook may include an indexed set of beamforming elements, and may further include a first subset of elements for phase-only antenna control, and at least one of a second subset of elements for antenna subset selection, and a third subset of elements for single antenna selection.

Applicant hereby claims priority under 37 C.F.R § 1.55 based on EP Patent Application Number 06022252.8/EP06022252, filed in the European Patent Office on Oct. 24, 2006, entitled “Advanced Codebook for Multi-Antenna Transmission Systems,” the disclosure of which is hereby incorporated by reference.

### TECHNICAL FIELD

The present disclosure relates to a method, system, transmitter apparatus, receiver apparatus, and computer program product for providing feedback signaling in a multi-antenna transmission system, such as a multiple-input multiple-output (MIMO) system.

### BACKGROUND

In wireless communication systems, multiple antennas can be used to improve link reliability and/or increase transmission rate. Generally, multiple-antenna techniques can be classified as either open loop mode or closed loop mode, depending on the availability of channel state information at the transmitter. Closed loop methods, such as precoding or beamforming, may lead to better performance at the expense of a requirement to feed back some form of channel state information (CSI) to the transmitting end.

The required CSI at the transmitting end can be maintained via feedback from the receiver in FDD (Frequency Division Duplex) mode, or through the reciprocity principle in TDD (Time Division Duplex) mode. Alternatively, in FDD mode the receiving end might decide on a transmit strategy, e.g., antenna weighting, and feed back this information via a feedback channel after proper quantization.

Transmit beamforming or precoding and receive combining are methods for exploiting diversity available in multiple-input and multiple-output (MIMO) wireless systems. In such MIMO systems, antenna arrays may be used to enhance bandwidth efficiency. MIMO systems provide multiple inputs and multiple outputs for a single channel, and are thus able to exploit spatial diversity and spatial multiplexing. Further information about MIMO systems can be gathered from the IEEE specifications 802.11n 802.16-2004 and 802.16e, as well as 802.20 and 802.22 which relate to other standards. Specifically, MIMO systems have been introduced to radio systems like e.g. WiMAX (Worldwide Interoperability for Microwave Access) and are currently standardized in 3GPP for WCDMA (Wideband Code Division Multiple Access) as well as 3GPP E-UTRAN (Evolved Universal Mobile Telecommunications System (UMTS) Terrestrial Radio Access Network), such as LTE (Long Term Evolution) or 3.9G.

Unfortunately in transmission systems where forward and reverse channels are not reciprocal, this may require coarse quantization of the channel and beamforming vector to accommodate the limited bandwidth of the feedback channel. To support such limitations of the feedback channel, codebooks of possible beamforming vectors can be used, which are known to both transmitting and receiving ends. The codebook may have fixed cardinality and may be designed off-line. The receiving end (e.g. mobile station) may select from the available codebook the best beamforming vector or matrix and to convey it over the feedback channel to the transmitting end (e.g. base station). More specific, the receiving end learns the CSI from received DL information and selects a transmit beamforming vector or matrix from the available codebook. An index of the selected beamforming vector or matrix is then fed back to transmitting end. Having received the index, the transmitting end looks up the corresponding codebook and selects the beamforming matrix or vector according to the index. The selected matrix or vector can then be used for MIMO precoding operation.

In current WCDMA-based 3GPP standard TS 25.202, for precoding or beamforming of two transmission antennas, Mode 1 and Mode 2 are defined, corresponding to a 2-bit and 4-bit codebook, respectively, which may as welt be extended to a case of four transmission antennas, e.g., a 6-bit codebook for Mode 1. Furthermore, D. J. Love and R. W. Heath, “Grassmannian beamforming for multiple-input multiple-output wireless systems”, IEEE Transactions on Information Theory, vol. 49, No. 10, pp. 2735-2747, October 2003 discloses Grassmannian packing as an optimum solution for the finite-rate feedback problem from a perspective of outage probability and SNR maximization, which leads to a so-called “Grassmannian codebook”. Additionally, a system unitary construction method is proposed in B. M. Hochwald, T. L. Marzetta, T. J. Richardson, W. Sweldens, and R. Urbanke, “Systematic design of unitary space-time constellations”, IEEE Transactions on Information Theory, vol. 46, No. 6, pp. 1962-1973, September 2000 to design a unitary space-time constellation for non-coherent transmission. This method can also be used to construct precoding or beamforming weights, which leads to phase-only weighting and has circular correlation property.

Moreover, Intel et al, “Compact codebooks for transmit beamforming in closed-loop MIMO”, IEEE C802.16e-05/050r6 disclose codebook for four transmission antennas, which is based on a Household transform and has been standardized into IEEE standard 802.16e-2005, “part 16: Air interface for fixed and mobile broadband wireless access systems”. In addition. P. Xia and G. B. Giannakis, “Design and analysis on transmit-beamforming based on limited-rate feedback”, IEEE Transactions on Signal Processing, vol. 54, No. 5, pp. 1853-1863, May 2006 suggests using a modified Lloyd algorithm to design the codebook.

In practice, the feedback mechanism may lead to imperfect or partial CSI at the transmitting end. Feedback delay, channel estimation errors, etc. may influence the accuracy of weights available at the transmitting end. Another imperfection may include a bandwidth constraint over the feedback link. For instance, in 3GPP WCDMA specification, only one bit for feedback of precoding or beamforming weights is typically transmitted in each slot, resulting in a 1500 bps signaling overhead. Therefore, an issue related to precoding/beamforming is how to design the codebook, such as how to quantize the channel state information or precoding information so that good performance with low feedback overhead can be achieved.

### SUMMARY

One example embodiment may include maintaining a codebook comprising an indexed set of beamforming elements, selecting at least one of said beamforming elements, and feeding back an index information of said at least one selected beamforming element to a multi-antenna transmitting end of said multi-antenna transmission channel. In this embodiment, the codebook may be maintained at a receiving end of a multi-antenna transmission channel. The at least one of said beamforming elements may be selected at the receiving end based on at least one predetermined parameter of said multi-antenna transmission channel. Also in this embodiment, the codebook may include a first subset of elements for phase-only antenna control, and at least one of a second subset of elements for antenna subset selection and a third subset of elements for single antenna selection.

Another example embodiment may include maintaining a codebook comprising an indexed set of beamforming elements, receiving a data stream which comprises an index information fed back from a receiving end of said multi-antenna transmission channel, and controlling beamforming at said multi-antenna transmitting end based on said indicated beamforming element. In this embodiment, the codebook may be maintained at a multi-antenna transmitting end of a multi-antenna transmission channel. The data stream is received at said multi-antenna transmitting end. The index information indicates a beamforming element selected from the codebook. Also in this embodiment, the codebook may include a first subset of elements for phase-only antenna control, and at least one of a second subset of elements for antenna subset selection or a third subset of elements for single antenna selection.

Another example embodiment may include a maintaining unit, at least one receiving unit, and a control unit. In this embodiment, the maintaining unit is configured to maintain a codebook comprising an indexed set of beamforming elements. The at least one receiving unit is configured to receive an index information fed back from a receiving end, said index information indicating a beamforming element selected from said codebook. The control unit is configured to control beamforming at said transmitter apparatus based on said indicated beamforming element. The codebook comprises a first subset of elements for phase-only antenna control, and at least one of a second subset of elements for antenna subset selection and a third subset of elements for single antenna selection.

Another example embodiment may include a maintaining unit, a selecting unit, and a feedback unit. In this embodiment, the maintaining unit may be configured to maintain a codebook comprising an indexed set of beamforming elements. The selecting unit may be configured to select at least one of said beamforming elements based on at least one predetermined parameter of a multi-antenna transmission channel. The feedback unit may be configured to feed back an index information of said at least one selected beamforming element to a multi-antenna transmitting end of said multi-antenna transmission channel. The codebook may include a first subset of elements for phase-only antenna control, and at least one of a second subset of elements for antenna subset selection and a third subset of elements for single antenna selection.

The details of one or more implementations are set forth in the accompanying drawings and the description below. Other features will be apparent from the description and drawings and from the claims.

### BRIEF DESCRIPTION OF THE DRAWINGS

FIG. 1 shows a schematic diagram of a multi-antenna transmission system according to an example embodiment.

FIG. 2 shows a schematic block diagram of a mobile transceiver unit according to an example embodiment.

FIG. 3 shows a schematic block diagram of a base station device according to an example embodiment.

FIG. 4 shows a schematic representation of a codebook structure according to an example embodiment.

FIG. 5 shows another schematic representation of a codebook structure according to an example embodiment.

FIG. 6 is a flow diagram of a receiver-side feedback process according to an example embodiment.

FIG. 7 is a flow diagram of a transmitter-side feedback process according to an example embodiment.

FIG. 8 is a graph showing simulation results of SNR gains of different Hochwald-type codebooks according to various embodiments.

FIG. 9 is a graph showing simulation results of SNR gains of a specific Hochwald-type codebook in comparison with other codebook types according to an example embodiment.

FIG. 10 shows a schematic block diagram of a computer-based implementation of an example embodiment.

### DESCRIPTION OF EMBODIMENTS

An example embodiment will now be described based on a wireless multi-antenna transmission system, such as—but not limited to—a MIMO system with a general uplink (UL) feedback scheme for MIMO downlink (DL) transmission for an example case of four available transmission antennas at a transmitter unit of a base station device, such as a Node B. However, it will be apparent from the following description and is therefore explicitly stressed that the present disclosure can be applied to other embodiments, such as, for example, another network architecture with different radio access technologies involving multi-antenna transmitter devices (e.g. base station devices, access points or other access devices) capable of being operated in different operating modes.

In transmission systems where forward and reverse channels are not reciprocal, MIMO systems may require coarse quantization of the channel and a beamforming vector to accommodate the limited bandwidth of the feedback channel. To support such limitations of the feedback channel, codebooks of possible beamforming vectors can be used, which are known to both the transmitting and receiving ends. The codebook is restricted to have fixed cardinality and may be designed off-line. The receiving end (e.g. mobile station) is assumed to select from the available codebook the best beamforming vector or matrix and to convey it over the feedback channel to the transmitting end (e.g. base station). More specifically, the receiving end learns the CSI from received downlink information and selects a transmit beamforming vector or matrix from the available codebook. An index of the selected beamforming vector or matrix is then fed back to the transmitting end. Having received the index, the transmitting end looks up the corresponding codebook and selects the beamforming matrix or vector according to the index. The selected matrix or vector can then be used for MIMO precoding operation.

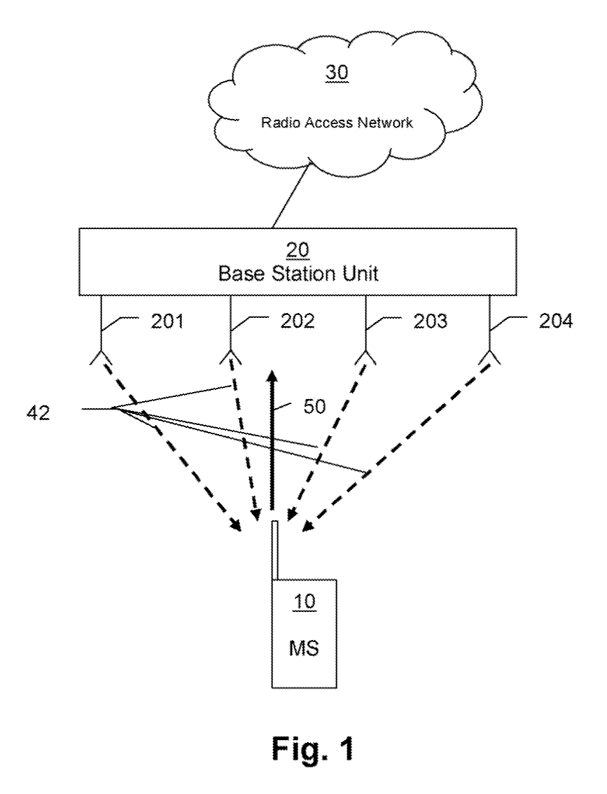

FIG. 1 shows an example embodiment of a multi-antenna system, in which a mobile station (MS) 10 (or UE in 3G terminology) is radio-connected to a base station device (BS) 20 (or Node B in 3G terminology) which comprises a plurality of, such as four, transmission antennas 201 to 204 for transmitting a respective downlink radio transmission 42 towards the mobile station 10. In this example embodiment, the mobile station 10 transmits an uplink transmission 50 towards the base station device 20 which provides access to a radio access network 30, such as an E-UTRAN or the like. The uplink signal may be received at the base station device 20 by the same antennas 201 to 204 through which the base station device 20 transmitted the downlink radio transmission 42, or an additional reception antenna may alternatively be provided. The mobile station 10 may alternatively have more than a single antenna available that could be used for dual-antenna or multi-antenna transmission in uplink direction and/or dual- or multi-antenna reception of downlink radio transmissions 42.

According to an example embodiment, a new 6-bit codebook is disclosed (below) for the four transmission antennas 201 to 204, which may provide better performance than conventional codebooks, considering different correlation and scenarios. The 6-bit codebook may comprise a combination of a first codebook (or first codebook subset) for phase-only transmission control and at least one of two other codebooks (or second and third codebook subsets) for antenna subset selection and single-antenna selection, respectively. As an example, the first codebook may be a Hochwald codebook or any other type of codebook which provides phase-only transmission control of the transmission beams generated by the transmission antennas.

Additionally, in a specific example of four transmission antennas, a size-48 Hochwald codebook may be used, which may be enhanced by a size-16 codebook comprising the second and third codebook subsets. The second codebook subset may comprise twelve codebook elements (e.g., precoding or beamforming vectors) for antenna subset selection, and the third codebook may comprise four codebook elements for single antenna selection.

Corresponding other codebook sizes may be utilized for a different number of transmission antennas, considering, for example, the tradeoff between overhead and performance.

In an example embodiment, the transmitter and receiver may maintain or store a common codebook, such as a finite collection of precoding vectors (codewords). In this example embodiment, the receiver determines which vector(s) are selected to be used from the codebook and then feeds its index back to the transmitter via a feedback channel. After receiving the codeword index, the transmitter determines the corresponding beamforming or precoding vector(s) for data transmission. The selection of proper beamforming or precoding weights from the codebook may follow some criterion, such as maximizing the post-processing SNR or maximizing the sum of the throughput of all streams, as non-limiting examples.

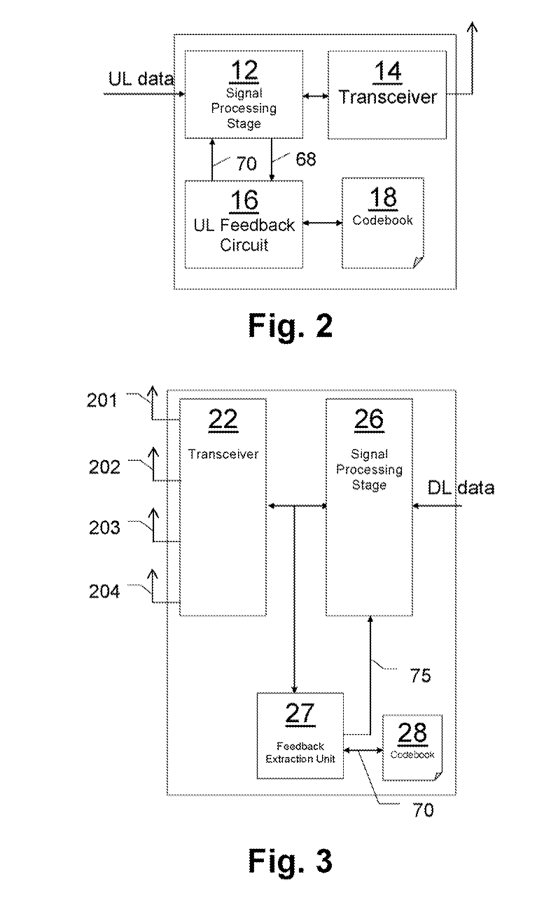

FIG. 2 shows a schematic block diagram of a transmit and receive unit according to an example embodiment, such as the mobile station 10, which may be configured to support or implement advanced feedback signaling with a mode indicator. Access to the radio access network 30 may be provided by a transceiver unit 14 capable of receiving and transmitting RF signals via at least one antenna. In another example embodiment, the transceiver unit 14 may comprise or may be replaced by separate transmitter and receiver units with separate transmission and receiving paths.

The transceiver unit 14 may be in communication with a signal processing stage 12, the latter of which may be responsible for receiver-related processing, such as demodulating, descrambling, decoding etc. of received downlink data, and/or for transmitter-related processing, such as modulating, scrambling, coding etc. of uplink data to be transmitted, and which may also be configured to add feedback information for precoding or beamforming to the uplink data stream. This feedback information may comprise an index to an element of a codebook 18, which may maintain or store an uplink feedback circuit 16. The uplink feedback circuit 16 may generate uplink feedback index information 70 based on a corresponding control information issued by the signal processing stage 12. The uplink feedback index information 70 may comprise an index to an element of a codebook 28 (shown in FIG. 3). The uplink feedback index information may then be added, e.g. as a binary control word, to the uplink stream and transmitted via the uplink transmission 50 toward the radio-connected base station device 20, as shown in FIG. 1.

FIG. 3 shows a schematic block diagram of a base station device, e.g. the base station device 20 shown in FIG. 1, according to an example embodiment. This example embodiment may include four antennas 201 to 204 for transmitting and receiving data. In this example, the four antennas 201 to 204 are coupled to a single transceiver unit 22, which may be capable of processing four transmission and reception streams. Each of the four antennas 201 to 204 may be connected to a single dedicated transceiver unit. In another example embodiment, the four antennas 201 to 204 may be pure transmission antennas, while at least one separate reception antenna may be provided for receiving an uplink data stream with the feedback index information 70. A feedback extraction unit 27 may also be provided, to which the received uplink data may be supplied to extract or derive the feedback index information 70, and other possible feedback information. The transceiver unit 22 may also be coupled to a signal processing stage 26 responsible for receiver-related processing, such as demodulating, descrambling, decoding etc. for received uplink data, and for transmitter-related processing, such as modulating, scrambling, coding, beamforming, user selection etc. for downlink data to be transmitted. The signal processing stage 26 may be controlled by a codebook element 75, which may be a codeword, vector, or matrix, for example, and which may be indexed by the feedback index information 70 in a codebook 28 maintained or stored at the feedback extraction unit 27. The codebook 28 may correspond to the codebook 18 of the transmit and receive unit shown in FIG. 2, so that the indexed codebook element corresponds to the indexed codebook element selected at the transmit and receive unit. The signal processing stage 26 may control beamforming for multi-antenna transmission based on the indexed codebook element 75, for example, by applying corresponding real and/or complex weights indicated by the indexed codebook element 75 to transmission signals transmitted via the antennas 201 to 204.

In an alternative example embodiment, the codebook 28 may be maintained or stored at the signal processing unit 26, wherein the feedback index information 70 may be supplied by the feedback extraction unit 27 to the signal processing unit 26.

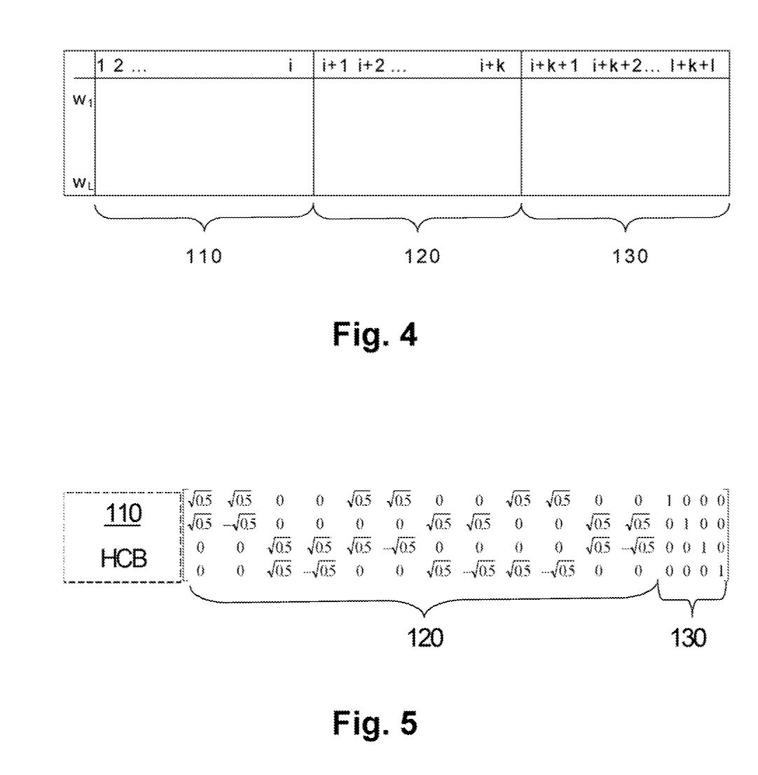

The generation of the enhanced codebooks 18 and 28 is now described with reference to FIGS. 4 and 5.

FIG. 4 shows a schematic representation of an example of the codebooks 18 and 28 shown as a table of codebook elements which include weights w₁ to w_{L} arranged as columns and which are indexed by numbers 1 to i+k+l indicated in the top row of FIG. 4. These index numbers directly or indirectly correspond to the above feedback index information 70. Thus, a total number of i+k+l codebook elements is provided and separated into a first subset 110 of i elements, a second subset 120 of k elements, and a third subset 130 of l elements. It is noted that the arrangement of the three subsets 110 to 130 may vary, and any possible interleaved or even non-regular structure could be used; in some embodiments, the location of codebook elements of each subset is known and indexed by an associated index number. In an alternative embodiment, the first subset 110 may be enhanced by only one of the second and third subsets 120 130, so that the codebook comprises only two subsets.

According to the example embodiment shown in FIG. 4, the first subset 110 of codebook elements includes weights for phase-only antenna control, such as complex weights which affect only the phase of the transmission signal transmitted via the associated antenna. The weights of the codebook elements of the second subset 120 may be used for antenna subset selection control, which means that they can be used to transmit the transmission signal only via a corresponding subset of all antennas 201 to 204, such as only two antennas. Finally, the weights of the third subset 130 of the elements may be configured to provide single antenna selection control, which means that the codebook elements of the third subset 130 may serve to transmit the transmission signal via only a single one of the antennas 201 to 204.

FIG. 5 shows another example embodiment of a codebook. In this example, the first subset 110 of the codebooks 18 and 28 includes a size-48 Hochwald codebook {w₁ w₂ . . . w_{L}} (HCB) which has a circular correlation property and can be generated with the following relationship:

wₗ=Q^{l-1}w₁, l=2,3, . . . L

where L is the size of the Hochwald codebook (48 in the present example of four antennas 201 to 204), w₁ is the first element, which can be chosen to be one column of Mₜ×Mₜ IDFT (Inverse Digital Fourier Transformation) matrix, for example

$${w}_{1} = {\frac{1}{\sqrt{{M}_{t}}} [ {e}^{j \frac{2 π}{{M}_{t}} o} {e}^{j \frac{2 π}{{M}_{t}} l} … {e}^{j \frac{2 π}{{M}_{t}} ( {M}_{t} - 1 )} ]}^{T}$$

where Mₜ is the number of transmit antennas, and the above rotation matrix Q is a diagonal matrix constructed by an integer rotation vector u=└u₁ u₂ . . . u_{M}_{ₜ}┘, 0≦u₁, u₂, . . . , u_{M}_{ₜ}≦L=1,

$$Q = [ \begin{matrix}{e}^{j \frac{2 π}{L} {u}_{j}} & & 0 \\ & ⋰ & \\ 0 & & {e}^{j \frac{2 π}{L} {u}_{{M}_{t}}}\end{matrix} ] .$$

The choice of the rotation vector may minimize the maximum correlation between elements in the codebook. The exemplary 48 elements may all lead to phase-only adaptation from the four antennas 201 to 204, providing good performance in strong correlated channel.

Additionally, the last sixteen elements in the codebook may cover the second and third subsets 120 and 130, and may include twelve elements of the second subset 120 for antenna subset (e.g., antenna pair) selection with zero or π relative phase rotation, and an additional four elements of the third subset 130 for single antenna selection. This selection of codebook elements may help the proposed codebook to improve the performance in uncorrelated channel in addition to phase-only weighting achieved by the incorporated Hochwald codebook of the first subset 110.

The example codebook described with reference to FIG. 5 can be denoted as “48+12+4” since it includes a size-48 Hochwald codebook (first subset 110), a size-12 two-antenna selection codebook (second subset 120), and a size-4 single-antenna selection codebook (third subset 130). It may thereby provide both phase-only weighting (via the first subset) and amplitude-only weighting (in the third subset) as well as the combination of both (in the second subset), which may lead to good tradeoff as correlation changes.

As more general examples, improved Hochwald or other phase-only adaptation codebooks combine the Hochwald-type or other phase-only adaptation codebooks with antenna subset selection with phase rotation. In a general expression “x+y+z” means a codebook including size-x Hochwald or phase-only adaptation codebook, y elements of two or more antenna selection, and z elements of single antenna selection. In the specific but non-limiting case of a 6-bit codebook, the sum of x, y and z is sixty-four. The number z of single-selection codebook elements is thus the number of transmit antennas, while the number y of antenna-subset selection codebook elements depends also on the number of possible relative phases given two or more selected antennas. For example, for a “48+12+4” codebook, two antennas are selected and the two relative phases are zero or π, so that y=2*C(4,2)=12. For a “42+18+4” codebook, the three different relative phases are zero, 2*π/3 and 4*π/3. For a “36+24+4” codebook, relative phases are zero, π/2, π and 3*π/2, and so on. This can be basically written as phases φᵢ=(i−1)·2π/L, 1≦i≦L having L different phase states.

As another example, “(64−m)+y+z” means a codebook including a size-64 Hochwald codebook, in which m elements have been left out, y elements of two antenna selection, and z elements of the single antenna selection. The sum of 64−m, y and z is 64, white y and z have the same meaning as in the above “x+y+z” codebook.

The above “48+12+4” codebook example provides weights for both single antenna selection and antenna subset selection. It includes twenty-four orthogonal pairs (eighteen pairs from weights for antenna subset selection and six pairs from weights for single antenna selection) which can be used for two stream transmission. The number of additional orthogonal pairs in the first subset of the codebook is dependent on the selected phase-only adaptation codebook or Hochwald codebook. Pairs of weights for single antenna selection can be used, for example, for 4×2 S-PARC (Selective-Per Antenna Rate Control) systems. The weights for antenna subset selection corresponds to a generalization of a 1-bit TxAA mode 1 and antenna selection. Some orthogonal pairs of weights for antenna subset selection can also be used for Double TxAA, DSTTD-SGRC (Double STTD—Sub Group Rate Control) or GS-PARC (Group Selective Per Antenna Rate Control).

The combination of elements of the at least one of the second and third codebook subsets with the first codebook subset may help the disclosed codebook to improve the performance in uncorrelated channel in addition to phase-only weighting from first codebook subset. A structured approach may thus, for example, be used to generate the codebook. This structured approach allows generation of the codebook when necessary, which means that codebook elements (e.g., codeword, vectors or matrices) do not have to be stored all the time, which is advantageous over some random-searched codebooks, e.g., Grassmannian and Xia's codebooks.

In an embodiment, the third subset of elements for single antenna selection may comprise a number of elements corresponding to the number of transmission antennas. The second subset of elements may comprise elements for antenna subset selection with L different relative phase rotations φᵢ=(i−1)·2π/L, 1≦i≦L between selected antenna elements. The first subset of beamforming elements may comprises a Hochwald-type codebook with a circular correlation property.

In specific implementation example, the multi-antenna transmitting end may comprise four antennas. The second subset of elements may then comprise twelve elements for antenna subset selection of two selected antennas with zero or π relative phase rotation. The Hochwald-type codebook of the first subset may have a size of 48 elements.

Other combinations according to FIG. 4 with or without Hochwald-type or other phase-only adaptation codebook subsets are envisioned.

As mentioned above, a structured approach may be used to generate the codebook. The generation of the codebook may be performed when the codebook is needed, which means that there may be no need to store the codebook elements all the time.

Better performance may be achieved for the proposed codebook considering different correlation and scenarios.

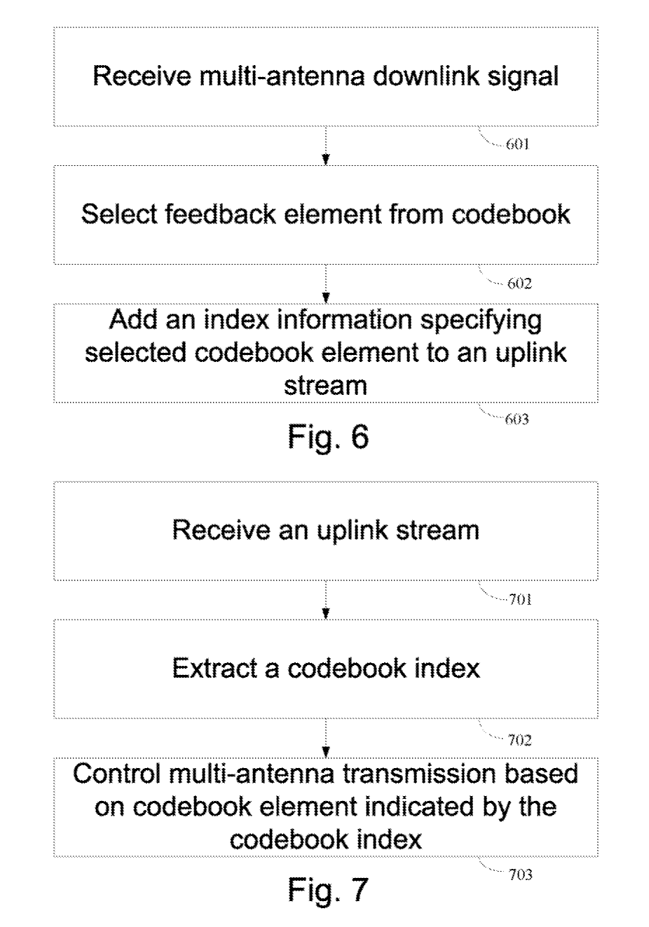

FIGS. 6 and 7 show flow diagrams of processes which may be performed at both radio communication ends of a MIMO transmission system with multiple transmission antennas according to an implementation example with the proposed advanced feedback signalling, according to an example embodiment.

An example process which may be performed at the receiving end, for example, at the mobile station 10 (shown in FIG. 1), is shown in FIG. 6. This example comprises receiving a multi-antenna downlink signal (601). A desired codebook element for optimized transmission may be selected from the codebook 18, and a corresponding index number may be derived (602). The feedback index information 70 may be added to the uplink transmission stream and forwarded to the transmitting end of the MIMO system (603).

An example process which may be performed at the transmitting end, for example, at the base station device 20 (shown in FIG. 1), is shown in FIG. 7. This example process includes receiving an uplink stream with the incorporated feedback index information 70 (701). The incorporated feedback index information 70 may be extracted (702). The extracted feedback index information 70 may be used to access the codebook 28 in order to derive the indexed codebook element 75 (703). The transmitting end may be capable of controlling beamforming for multi-antenna transmission based on the derived codebook element 75.

The processes described with reference to FIGS. 6 and 7 may be performed by computer program products comprising code means which are run on a computer device.

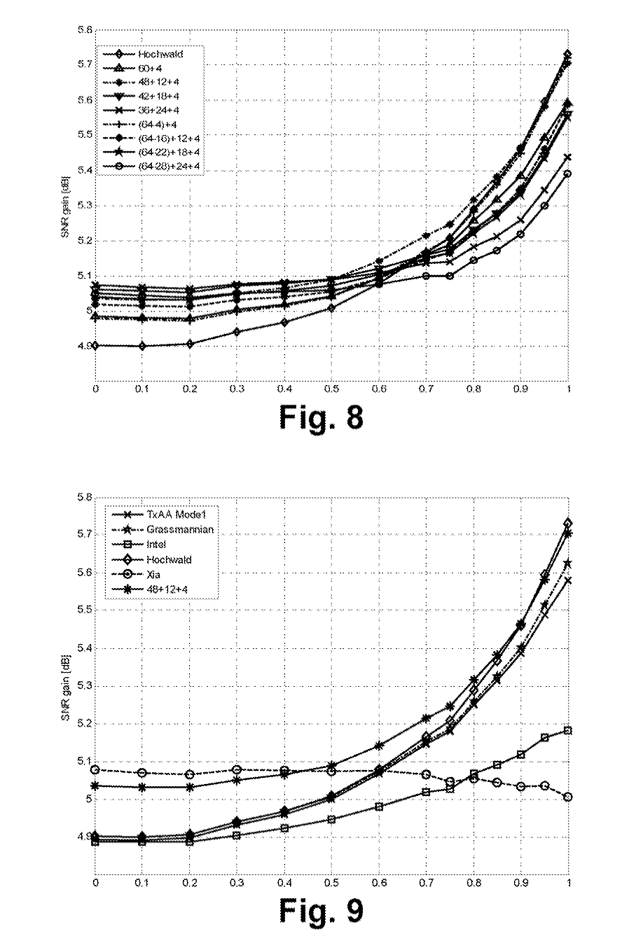

FIGS. 8 and 9 are graphs showing simulation results of SNR gains over a flat fading channel of different Hochwald-type codebooks according to various embodiments in dependence on different transmission correlation factors.

FIG. 8 shows simulation results for different Hochwald and improved Hochwald codebooks, which indicate that codebook-type “x+y+z” is better than codebook-type “(64−m)+y+z”, except the two cases with only single antenna selection, namely, types “60+4” and “(64−4)+4”. These results indicate that codebook type “48+12+4” provides the best overall performance.

These results also indicate that two antennas selection achieved by the above second codebook subset 120 (i.e., parameter y) may improve performance in a weak- or medium-correlated channel in addition to single antenna selection.

FIG. 9 shows simulation results for improved Hochwald codebook type “48+12+4” in comparison with other conventional codebook types TxAA Mode 1, Grassmannian, Intel, Hochwald, and Xia. These results indicate that the codebook-type “48+12+4” is better than the other codebook types.

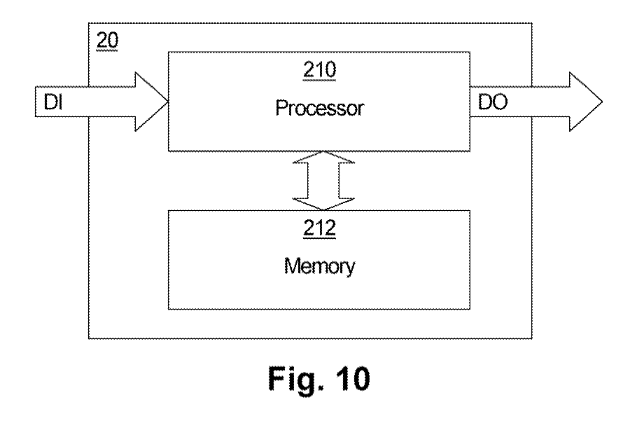

FIG. 10 shows a schematic block diagram of a software-based implementation of the proposed advanced feedback transmission system according to an example embodiment. In this example, the transmitter 22 shown in FIG. 3 and the receiver 14 shown in FIG. 2 comprise a processor 210. In some embodiments, the processor 210 may be any processor or computer device with a control unit which performs control based on software routines of a control program stored in a memory 212. Program code instructions may be fetched from the memory 212 and loaded to the control unit of the processor 210 to perform the processes described with reference to FIGS. 6 and 7, or with reference to blocks 12, 16 and 18 of FIG. 2, or with reference to blocks 26, 27 and 28 of FIG. 3. These processes may be performed in response to input data DI and may result in output data DO, wherein at the receiver end the input data DI may correspond to the received downlink data and the output data DO may correspond to the feedback index information 70. At the transmitter side, the input data may correspond to the received uplink data and the output data may correspond to control information (e.g. weights) required to control beamforming of the multi-antenna transmission.

It is to be noted that the present disclosure is not restricted to the embodiments described above, but can be implemented, for example, in another network environment involving multi-antenna transmission controlled by feedback signaling. Another signaling format or means can be used for feeding back the feedback information, which may be an index information or even the codebook element itself. Moreover, another kind of codebook structure may be used for arranging the first codebook subset and the at least one of the second and third codebook subsets. Alternative embodiments may thus vary within the scope of the attached claims.

1. A method comprising:
Maintaining, at a receiving end of a multi-antenna transmission channel, a codebook comprising an indexed set of beamforming elements;
selecting, at said receiving end, at least one of said beamforming elements based on at least one predetermined parameter of said multi-antenna transmission channel; and
feeding back an index information of said at least one selected beamforming element to a multi-antenna transmitting end of said multi-antenna transmission channel;
wherein said codebook comprises a first subset of elements for phase-only antenna control, and at least one of: a second subset of elements for antenna subset selection or a third subset of elements for single antenna selection.

2. The method of claim 1, wherein said codebook comprises the third subset of elements for single antenna selection, which comprises a number of elements corresponding to a number of transmission antennas.

3. The method of claim 1, wherein said codebook comprises the second subset of elements, which comprises elements for antenna subset selection with L different relative phase rotations φᵢ=(i−1)·2π/L, 1≦i≦L between selected antenna elements.

4. The method of claim 1, wherein said first subset of beamforming elements comprises a Hochwald-type codebook with a circular correlation property.

5. The method of claim 1, wherein said multi-antenna transmitting end comprises four antennas.

6. The method of claim 1, wherein said codebook comprises the second subset of elements, which comprises twelve elements for antenna subset selection of two selected antennas with zero or π relative phase rotation.

7. The method of claim 1, wherein said first subset comprises a Hochwald-type codebook with a size of 48 elements.

8. A method comprising:
maintaining, at a multi-antenna transmitting end of a multi-antenna transmission channel, a codebook comprising an indexed set of beamforming elements;
receiving, at said multi-antenna transmitting end, a data stream which comprises an index information fed back from a receiving end of said multi-antenna transmission channel, said index information indicating a beamforming element selected from said codebook; and
controlling beamforming at said multi-antenna transmitting end based on said indicated beamforming element;
wherein said codebook comprises a first subset of elements for phase-only antenna control, and at least one of: a second subset of elements for antenna subset selection or a third subset of elements for single antenna selection.

9. The method of claim 8, wherein said codebook comprises the third subset of elements for single antenna selection, which comprises a number of elements corresponding to a number of transmission antennas.

10. The method of claim 8, wherein said codebook comprises the second subset of elements, which comprises elements for antenna subset selection with L different relative phase rotations φᵢ=(i−1)·2π/L, 1≦i≦L between selected antenna elements.

11. The method of claim 8, wherein said first subset of beamforming elements comprises a Hochwald-type codebook with a circular correlation property.

12. The method according of claim 8, wherein said multi-antenna transmitting end comprises four antennas.

13. The method of claim 8, wherein said codebook comprises the second subset of elements, which comprises twelve elements for antenna subset selection of two selected antennas with zero or π relative phase rotation.

14. The method of claim 8, wherein said first subset comprises a Hochwald-type codebook with a size of 48 elements.

15. An apparatus comprising:
a maintaining unit configured to maintain a codebook comprising an indexed set of beamforming elements;
at least one receiving unit configured to receive an index information fed back from a receiving end, said index information indicating a beamforming element selected from said codebook; and
a control unit configured to control beamforming based on said indicated beamforming element;
wherein said codebook comprises a first subset of elements for phase-only antenna control, and at least one of: a second subset of elements for antenna subset selection or a third subset of elements for single antenna selection.

16. The apparatus of claim 15, wherein said codebook comprises the third subset of elements for single antenna selection, which comprises a number of elements corresponding to a number of transmission antennas.

17. The apparatus of claim 15, wherein said codebook comprises the second subset of elements, which comprises elements for antenna subset selection with L different relative phase rotations φᵢ=(i−1)·2π/L, 1≦i≦L between selected antenna elements.

18. The apparatus of claim 15, wherein said first subset of beamforming elements comprises a Hochwald-type codebook with a circular correlation property.

19. The apparatus of claim 15, wherein said maintaining unit comprises four antennas.

20. The apparatus of claim 15, wherein said codebook comprises the second subset of elements, which comprises twelve elements for antenna subset selection of two selected antennas with zero or π relative phase rotation.

21. The apparatus of claim 15, wherein said first subset comprises a Hochwald-type codebook with a size of 48 elements.

22. An apparatus comprising:
a maintaining unit configured to maintain a codebook comprising an indexed set of beamforming elements;
a selecting unit configured to select at least one of said beamforming elements based on at least one predetermined parameter of a multi-antenna transmission channel; and
a feedback unit configured to feed back an index information of said at least one selected beamforming element to a multi-antenna transmitting end of said multi-antenna transmission channel;
wherein said codebook comprises a first subset of elements for phase-only antenna control, and at least one of: a second subset of elements for antenna subset selection or a third subset of elements for single antenna selection.

23. The apparatus of claim 22, wherein said codebook comprises the third subset of elements for single antenna selection, which comprises a number of elements corresponding to a number of transmission antennas in the multi-antenna transmitting end.

24. The apparatus of claim 22, wherein said codebook comprises the second subset of elements, which comprises elements for antenna subset selection with L different relative phase rotations φᵢ=(i−1)·2π/L, 1≦i≦L between selected antenna elements.

25. The apparatus of claim 22, wherein said first subset of beamforming elements comprises a Hochwald-type codebook with a circular correlation property.

26. The apparatus of claim 22, wherein said multi-antenna transmitting end comprises four antennas.

27. The apparatus of claim 22, wherein said codebook comprises the second subset of elements, which comprises twelve elements for antenna subset selection of two selected antennas with zero or it relative phase rotation.

28. The apparatus of claim 22, wherein said first subset comprises a Hochwald-type codebook with a size of 48 elements.

29. A computer program product comprising code means for producing the steps of method claim 1 when run on a computer device.

30. A computer program product comprising code means for producing the steps of method claim 8 when run on a computer device.
